(19) United States
(12) Patent Application Publication
(10) Pub. No.: US 2025/0291364 A1
(43) Pub. Date: Sep. 18, 2025

(54) MODULAR SENSOR PAYLOAD FOR ROBOTIC OPERATIONS

(71) Applicant: Dubai Future Foundation, Dubai (AE)

(72) Inventors: Roni Permana Saputra, Dubai (AE); Tarek Taha, Dubai (AE)

(73) Assignee: Dubai Future Foundation, Dubai (AE)

(21) Appl. No.: 19/069,576

(22) Filed: Mar. 4, 2025

Related U.S. Application Data
(60) Provisional application No. 63/565,869, filed on Mar. 15, 2024.

(51) Int. Cl. G05D 1/689; G05D 1/221; G05D 105/80; G06F 13/20

(52) U.S. Cl. CPC G05D 1/689; G05D 1/221; G06F 13/20; G05D 2105/89; G06F 2213/40

(57) ABSTRACT

Modular sensor payload systems coupled to a mobile robot for performing robotic operations and methods for operating the payload system. The payload system comprises one or more sensor systems, a primary payload comprising an onboard computation module; an onboard power module, and a communication system configured to establish communication between the mobile robot, the primary payload, and the one or more sensor systems, wherein the one or more sensor systems, the communication system, and the primary payload are configured to be electrically coupled in a modular configuration via an universal mounting interface provided on each of the one or more sensor systems, the communication system, and the primary payload, and wherein a given sensor system of the one or more sensor systems can be coupled to any other sensor system, the communication system, or the primary payload in the modular configuration.

### CROSS-REFERENCE TO RELATED APPLICATIONS

The present disclosure claims priority to and benefit of U.S. provisional patent application No. 63/565,869, an entitled MODULAR SENSOR PAYLOAD FOR ROBOTIC OPERATIONS, filed on Mar. 15, 2024, the entirety of which is hereby incorporated by reference herein.

### TECHNICAL FIELD

The present disclosure relates to a payload system for controlling robotic operations and in particular to a modular sensor payload system configured to be used with mobile robotic devices.

### BACKGROUND

Robotic devices, and particularly mobile robotic devices, have become indispensable tools for exploration and inspection tasks across a wide range of industries. These robotic devices may be deployed to more efficiently and effective perform tasks that are otherwise difficult, cost intensive, time consuming, or dangerous for humans to perform. For example, a robotic device may be configured to perform inspections or conduct searches in restricted spaces, buildings with structural damage caused by natural disasters, or dangerous environments such as spaces contaminated with chemical, radioactive, or biohazard agents. By relying on suitable robotic devices that are adapted for a particular application, these challenging operations can be executed while ensuring the safety of the workers.

As a result, robotic devices have been deployed to play a pivotal role in scenarios such as search and rescue missions, environmental monitoring, industrial inspections, and even space exploration. However, current robotic devices and systems can often become too specialized. That is, a robotic device tailored for one type of operation may be wholly unfit for a slightly different task and thus a number of different devices based on the operations to be performed is required, thereby incurring significant cost. Conversely, robotic devices that are more versatile may be less suitable or inadequate for a more specific operation. Further, to accommodate for different functions, additional components are necessitated, thereby increasing the cost, complexity, and size of the robotic devices. Although robotic payload systems comprising function based components have been explored in the past, such systems are limited in scope and lacking in adaptability and flexibility.

Accordingly, alternative, additional, and/or improved robotic systems or payload systems for performing a wide range of robotic operations remains highly desirable.

### SUMMARY

In accordance with one aspect of the present disclosure, a modular sensor payload system for a mobile robot is disclosed, comprising: one or more sensor systems, a primary payload comprising: an onboard computation module configured to process sensor data from the one or more sensor systems and to generate output data; an onboard power module configured to provide power to the modular sensor payload system, and a communication system comprising: a data connection module configured to provide communication between the onboard computation module and the one or more sensor systems; and a data interface module configured to provide communication between the modular sensor payload system and the mobile robot, and wherein the one or more sensor systems, the communication system, and the primary payload are configured to be electrically coupled in a modular configuration via an universal mounting interface provided on each of the one or more sensor systems, the communication system, and the primary payload, and wherein a given sensor system of the one or more sensor systems can be coupled to any other sensor system, the communication system, or the primary payload in the modular configuration.

In some aspects, the sensor data is wirelessly provided to the onboard computation module.

In some aspects, the power to the modular sensor payload system is provided through the universal mounting interface.

In some aspects, the output data is for controlling operations of the one or more sensor systems.

In some aspects, the output data is for controlling operations of the mobile robot.

In some aspects, the data interface module is further configured to provide communication between the payload system and one or more external devices; and the onboard computation module is configured to process information from the one or more external devices to generate the output data.

In some aspects, operations of the payload system is controlled by the one or more external devices.

In some aspects, operations of the mobile robot is controlled by the one or more external devices.

In some aspects, the output data is provided to the one or more external devices.

In some aspects, the one or more external devices is a phone, a computer, a remote controller, a database, or combinations thereof.

In some aspects, at least one sensor system comprises: a processor configured to process received data and control the operations of the at least one sensor system according to the received data.

In some aspects, the one or more sensor systems comprise a pan-tilt system configured to provide movement to at least one sensor system attached thereon.

In some aspects, the one or more sensor systems comprise one or more of: an optical camera system configured to capture camera images; an infrared camera system configured to capture infrared images; and a camera array system configured to capture visual images of a surrounding.

In some aspects, the one or more sensor systems comprise an inertial measurement system configured to measure acceleration, velocity, angular velocity, orientation, magnetic field orientation, or combinations thereof.

In some aspects, the one or more sensor systems comprise: a light detection and ranging system, a radar system, a GPS system, or combinations thereof.

In some aspects, the one or more sensor systems comprise: a microphone system, a gas sensor system, an environmental sensor system, or combinations thereof.

In some aspects, the modular sensor payload system further comprises a direct user interface configured to receive user input to control the modular sensor payload system and/or the mobile robot.

In some aspects, the universal mounting interface comprises a cooperating feature configured to provide an electrical interface.

In some aspects, the universal mounting interface is a magnetic connection interface or wireless connection interface.

In some aspects, the universal mounting interface comprises a male interface and a female interface, the male interface configured to be inserted in a corresponding female interface, and the female interface configured to receive a corresponding male interface.

In some aspects, the one or more sensor systems, the communication system, and the primary payload are configured to be physically coupled in the modular configuration via the universal mounting interface.

In accordance with another aspect of the present disclosure, a mobile robot for performing independent remote operations is disclosed, the mobile robot comprising: a main body, and a modular sensor payload system according to any one of the above aspects.

In accordance with another aspect of the present disclosure, a method of controlling a mobile robot using a modular sensor payload system is disclosed, the method comprising: detecting one or more sensor systems of the modular sensor payload system, establishing communication between the modular sensor payload system and the mobile robot, receiving input instructions from a user, operating the one or more sensor systems based on the input instructions, wherein the modular sensor payload system comprises: the one or more sensor systems, a primary payload comprising configured for robotic control, and a communication system configured to provide communication between the primary payload, the one or more sensor systems, and the user, and wherein the one or more sensor systems, the communication system, and the primary payload are configured to be electrically coupled in a modular configuration via an universal mounting interface provided on each of the one or more sensor systems, the communication system, and the primary payload, and wherein a given sensor system of the one or more sensor systems can be coupled to any other sensor system, the communication system, or the primary payload in the modular configuration.

In some aspects, the method further comprises: controlling operations of the mobile robot according to the input instructions and sensor data from the one or more sensor systems.

In some aspects, the method further comprises: generating output data for the user.

### BRIEF DESCRIPTION OF THE DRAWINGS

Further features and advantages of the present disclosure will become apparent from the following detailed description, taken in combination with the appended drawings, in which:

FIG. 1 shows a representation of a modular sensor payload system for a robotic device, according to an example embodiment;

FIG. 2a shows a representation of an embodiment of the modular sensor payload system of FIG. 1;

FIG. 2b shows an exploded view of the components of the embodiment of the modular sensor payload system of FIG. 1;

FIGS. 3a-3c show representations of various embodiments of the modular sensor payload system of FIG. 1;

FIG. 4 shows a representation of the a modular sensor payload system of FIG. 1 including the components;

FIGS. 5a and 5b show representations of embodiments of the modular sensor payload system of FIG. 1 with various robotic devices; and

FIG. 6 shows a method for operating a robotic device with the modular sensor payload system of FIG. 1.

It will be noted that throughout the appended drawings, like features are identified by like reference numerals.

### DETAILED DESCRIPTION

Exploration and inspection tasks across various sectors require robots to work successfully in complex and dynamic situations. These tasks include navigating unknown terrain, identifying potential risks, collecting useful data, and ensuring the safety of both the robot and its surroundings. To address these challenges, robots need to be able to adapt quickly and respond effectively to changing conditions, paving the way for innovative solutions that incorporate advanced technologies with real-time decision-making capabilities. To that end, a modular sensor payload system that can be employed as a standalone module for autonomous navigation, perception, and exploration is provided. The modular sensor payload system is comprised of multiple individual sensor modules that can be combined in a variety of modes based on the application's requirements.

The modular sensor payload system may comprise a wide range of multimodal sensors with an on-board computation device and is thus capable of performing exploration and inspection tasks autonomously. This versatile and adaptable system equips mobile robots with advanced sensing capabilities, enabling them to navigate complex environments, detect obstacles, analyze surroundings, and make informed decisions in real-time. By integrating a diverse array of multimodal sensors, including cameras, Light Detection and Ranging (LiDAR), infrared sensors, RADAR, gas sensors, and environmental sensors, the modular sensor payload can provide comprehensive data acquisition capabilities. Further, the on-board computation device may process the sensor data, utilizing sophisticated algorithms for perception, object recognition, and environmental mapping.

In particular, a modular sensor payload system, a mobile robot, and associated methods for performing a wide range of robotic operations are provided. The modular sensor payload system can be coupled to a mobile robot to form a robotic system for performing various tasks. The modular sensor payload system comprises an onboard power supply component for providing power to the system and/or mobile robot as well as at least one processor or a computation component for data processing and for controlling the operations of the payload system and/or the mobile robot. The payload system can also comprise a communication module comprising components therein configured to integrate and exchange data between users, the mobile robot, and/or various components of the payload system. One or more modular sensor systems as desired may also be coupled to the payload system. Each of the sensor systems may be configured for different functions and incorporated into the payload system as required by the robotic operation to be performed. Each component of the payload system comprises one or more universal mounting interfaces for electrical and structural coupling to another component of the modular sensor payload system. For example, a particular sensor system may be attached to the communication module or a different sensor system by means of the universal mounting interface. The universal mounting interface may be configured to electrically connect or couple the different components of the payload system for the supply of power and exchange of data. The users may also be able to control or monitor by means of an user interface provided on the payload system or through external devices.

The present disclosure can provide an adaptable solution for conducting robotic operations. In particular, a modular sensor payload system is provided, which may be utilized with, for example, a mobile robot performing exploration and inspection tasks. The modular configuration of the sensor systems through the implementation of the universal mounting interface can allow the users to choose specific sensor systems based on the needs of the robotic operations. That is, the components of the payload system can be customized such that only relevant sensor systems are deployed. As such, the payload system may be a versatile and adaptable solution for various applications, including industrial automation, environmental monitoring, disaster response, and security surveillance. The connections and design of the payload components may facilitate quick and simple attachment or detachment of different components. By customizing the payload system based on need, the present disclosure can provide a low cost alternative for performing various tasks without the need for different specialized robotic devices. Moreover, the size of the robotic device can be reduced compared to other general purpose robotic devices as unnecessary components can be omitted from the payload during setup.

As such, the devices, systems, and methods of the present disclosure may combine the benefits of modularity, flexibility, and advanced sensing technologies to enhance the robot's capabilities in exploration and inspection scenarios.

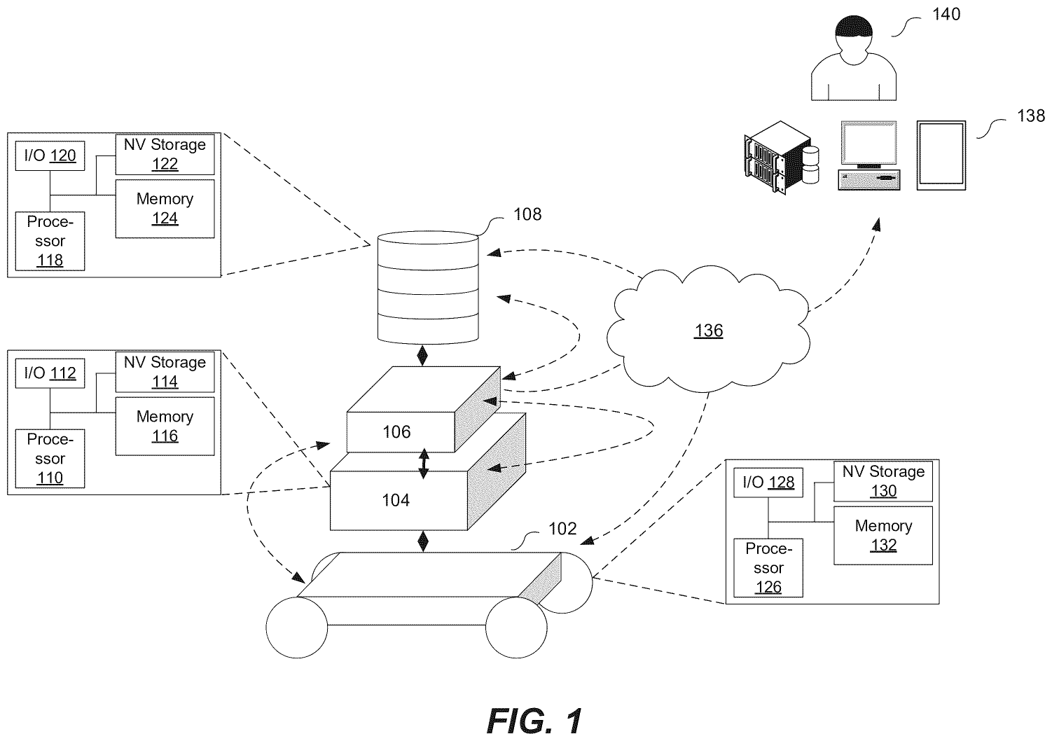

Embodiments are described below, by way of example only, with reference to FIGS. 1-6.

FIG. 1 depicts an embodiment of a modular sensor payload system for a mobile robot. The modular sensor payload system may be provided to operate in conjunction with, or to control the operations of a mobile robot 102. The mobile robot 102 may be configured to perform unsupervised or controlled remote operations. The mobile robot 102 may be a general purpose robot or a robot that is designed/adapted to operate at a specific area. For example, the mobile robot may be equipped with wheels or threads for traversing a particular type of environment or terrain that it is intended to operate in. The modular sensor payload system is configured such that constituent components may be coupled or decoupled as required by the intended or desired robotic operations. In a general embodiment, the modular sensor payload system comprises a primary payload system 104, a communication system 106, and one or more sensor modular sensor systems 108.

The primary payload system 104 may comprise a power supply for providing power to the part or the entirety of the modular sensor payload system and/or the mobile robot 102. The primary payload system 104 may also comprise an onboard computation module configured for data processing as well as for controlling the operations of the payload system and/or the mobile robot 102. For example, the payload system may comprise a processing unit 110, which may for example be a central processing unit (CPU), graphical processing unit (GPU), a microprocessor, or an application specific integrated circuit (ASIC). The primary payload system also comprises a non-transitory computer-readable memory 116, a non-volatile storage 114, and an input/output interface 112. The non-transitory computer-readable memory 116 comprises computer-executable instructions stored thereon at runtime which, when executed by the processing unit 110, configure the payload system to process various data, control the payload system, control the mobile robot 102, or a combination thereof, as described in more detail herein. The non-volatile storage 114 has stored on it computer-executable instructions that are loaded into the non-transitory computer-readable memory 112 at runtime and may be further configured to store various data, such as sensor data from the one or more modular sensor systems 108. The input/output interface 116 allows the payload system to communicate various information with other devices or components. According to some embodiments of the present disclosure, the input/output interface 116 may include a physical interface for user to interact with as to control the payload system.

The one or more modular sensor systems 108 may comprise individual sensor systems configured for specific purposes. The sensor systems may be a combination of, but not limited to: a pan-tilt module, an optical camera system, an infrared camera system, a camera array system, an inertial measurement system, a light detection and ranging system, a radar system, a GPS system, a microphone system, a gas sensor system, and an environmental sensor system. It should be noted that the choice of sensor systems can be dependent on the robotic operation to be performed. For example, for performing remote mapping, the one or more modular sensor systems 106 may comprise a camera array system, a radar system, and a GPS system. In such an operation, the inclusion of, for example, a gas sensor system or a microphone system is not require and may thereof be omitted. Each of the one or more modular sensor systems 108 may comprise a processing unit 118, a non-transitory computer-readable memory 124, a non-volatile storage 122, and an input/output interface 120. The non-transitory computer-readable memory 124 comprises computer-executable instructions stored thereon at runtime which, when executed by the processing unit 118, configure the specific sensor system to perform specific tasks, as described in more detail herein. The non-volatile storage 122 has stored on it computer-executable instructions that are loaded into the non-transitory computer-readable memory 124 at runtime and may be further configured to store sensor data of the corresponding sensor system. The input/output interface 120 allows the sensor system to communicate with the primary payload 104.

The communication system 106 may be configured to establish communication between the one or more modular sensor systems 108, the primary payload 104, and the mobile robot 102. The communication system 106 may normalize, harmonize, and/or integrate data to exchange information between components that it is in communication with. The data may include, for example, sensor data from the one or more modular sensor systems 108 and instructions for one or more modular sensor systems 108 the mobile robot 102. The data may be wired or wireless connection. For example, the data may be exchanged using Bluetooth, near-field communication, and/or WiFi. As depicted in FIG. 1, The communication system 106 may communicate with the one or more modular sensor systems 108, the primary payload 104, and the mobile robot 102 over a communication network 136. The communication system 106 may be additionally configured to communicate with one or more devices 138 over the communication network 136. Users 140 may be able to control the operations of them modular sensor payload system through the one or more devices 138, which may be done remotely. The one or more devices 138 may be, for example, a computer, a mobile phone, a tablet, or a remote controller that have interface provided thereon for controlling the payload system. The one or more devices may further comprises servers or databases for storing data from the payload system including sensor data and operation logs. In particular, the communication system 106 may transmit data from the payload system to the one or more devices for monitoring and data analysis.

The mobile robot 102 may also comprise a processing unit 126, a non-transitory computer-readable memory 132, a non-volatile storage 130, and an input/output interface 128. The non-transitory computer-readable memory 132 comprises computer-executable instructions stored thereon at runtime which, when executed by the processing unit 126, configure the mobile robot 102 to perform robotic operations, such controlled movement. The non-volatile storage 130 has stored on it computer-executable instructions that are loaded into the non-transitory computer-readable memory 132 at runtime. The input/output interface 128 allows the mobile robot 102 to communicate with the payload system. The mobile robot 102 may also be configured accept direct input by the user by means of a physical interface provided by the input/output interface 128.

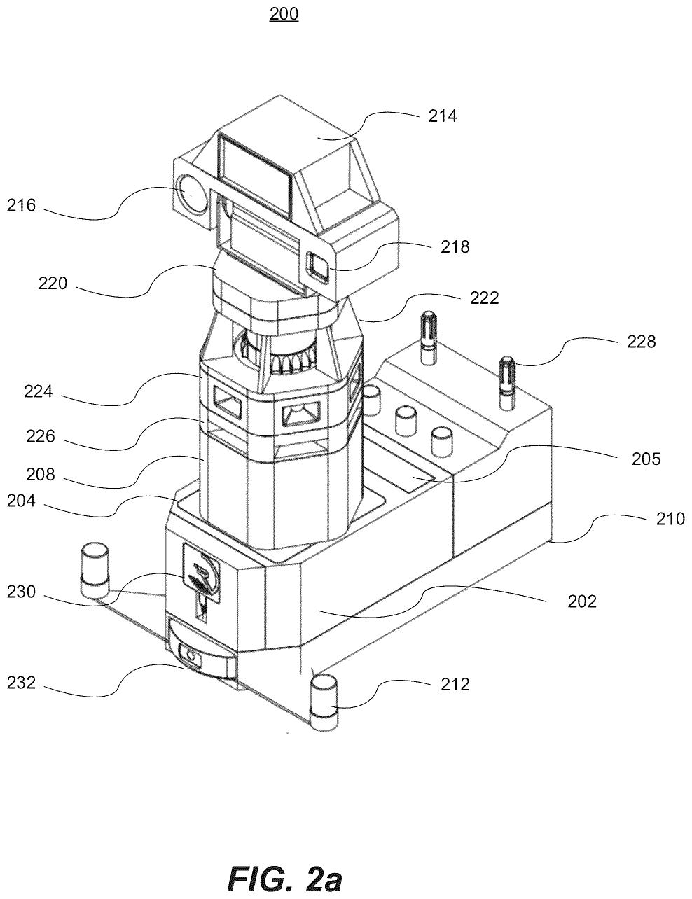

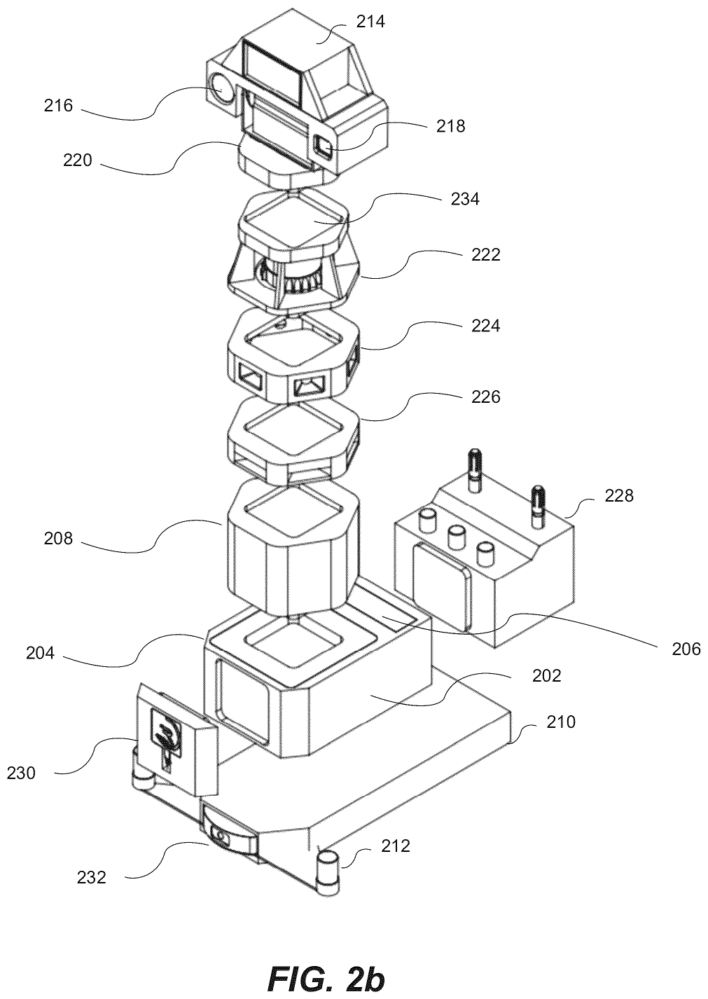

FIG. 2a depicts a perspective view of an embodiment of a modular sensor payload system in accordance with the present disclosure. FIG. 2b depicts the same modular sensor payload system in exploded view showing the components. The modular sensor payload system may be configured to be used with a mobile robot, forming a robotic system for performing robotic operations.

The modular sensor payload system 200 may comprise a primary payload system 202. The primary payload 202 can comprise an onboard computation module 204 and an onboard power module 206. The primary payload 202 may be coupled to one or more modular sensor systems and a modular communication system 208. The one or more modular sensor systems may include an optical camera system 216, an infrared camera system 218, a pan-tilt system 220, a LIDAR system 222, a camera array system 224, a microphone system 226, a gas sensor system 228, a radar sensor system 230, and a GPS system 232. A headlight 214 for providing illumination may also be provided with the payload system. The payload system 200 may also comprise a base 210 where the components of the payload system 200 may be mounted and coupled to. The base 210 may be configured for coupling the payload system 200 to a mobile robot. Further, the base 210 may be physically secured to the mobile robot at one or more connection locations 212. The physical coupling between the base 210 and the mobile robot may be achieve by means of screws, cooperating interface(s), or other conventional means for attachment.

The onboard power module 206 can be configured to provide power to the payload system 200 and optionally the mobile robot. Specifically, the power module may supply power to the onboard computation module 204, the communication system 208, and each of the one or more modular sensor systems. As an example, the onboard power module 206 may comprise a battery or similar power source. The onboard power module 206 may further comprise an associated power management system configured to optimize power distribution and delivery to the components of the modular sensor payload system 200 and each of the one or more modular sensor systems in particular. The onboard power module 206 may be an efficient power management system such that the operations of the mobile robot with the modular sensor payload system may be extended with reduced downtime.

The onboard computation module 204 may comprise one or more processors configured to process various data. The onboard computation module 204 may also be configured to control the one or more modular sensor systems, the communication system 208, and the mobile robot. In some embodiments, the onboard computation module 204 may also be configured to generate output data, such as sensor data and operational data, which may be used for data collection/analysis as well as the monitoring and control of the robotic operations. For example, the onboard computation module 204 may be a micro-controller or embedded/micro-computer. It should be noted that the onboard computation module 204 may be configured to process sensor data from the one or more modular sensor systems in real time. By running algorithms for perception, decision-making, and control, the computation module 204 can enable the robotic system to make autonomous decisions based on the sensor inputs/data. In particular, the computation module 204 may integrate data from the various sensor systems using advanced data fusion algorithms for data processing. The computation module 204 can also accept instructions and inputs from users by means of external devices such that the robotic system can be controlled remotely. Specifically, the computation module 204 may control the operations of the one or more modular sensor systems, the mobile robot, and the communication system 208.

The communication system 208 may be configured to establish communication between the various components of the robotic system. For example, the communication system 208 may be configured to facilitate the exchange of data between the primary payload 202, in particular the onboard computation module 204 with the one or more modular sensor systems and the mobile robot. In particular, communication system 208 may facilitate transfer of data such that the onboard computation module 206 may receive sensor data from the one or more modular sensor systems and provide instructions to the mobile robot and/or the one or more modular sensor systems. The communication system 204 can also harmonize, normalize, and integrate sensor data from the one or more modular sensor systems for processing by the computation module 204. According to a further embodiment, the communication system 208 may be additionally configured to establish communication between the components of the robotic system and one or more external devices. For example, the external devices may be phones, tablets, computers, or remote controllers used by one or more users, which can be used to control the operations of the robotic system by providing instructions to the onboard computation module 204. Correspondingly, the onboard computation module 204 may then control the operations of the mobile robot and the one or more modular sensor system. The communication system may enable the exchange of data wirelessly, for example, by means of a communication network (e.g. WiFi, telecommunication), Bluetooth, or NFC. As such, the operations and monitoring of the robotic system can be controlled/conducted remotely. The ability to perform remote operations can reduce costs, increase efficiency by localizing the users and removing the need for on-site work. Remote operation can also be particularly valuable in hazardous or inaccessible environments in allowing experts to supervise and perform critical operations from a safe distance.

The optical camera system 216 may comprise at least one optical zoom camera. The cameras of the optical camera system 216 may also comprise lenses that allow variable focal lengths and magnification levels. The optical camera system 216 is configured to provide high quality and detailed images of objections of interest. For example, optical camera system 216 capture high definition images of distant objects with precision by adjusting the physical lens elements.

The infrared camera system 218 may comprise at least one thermal and/or infrared cameras/sensors configured to detect and capture heat signatures and temperature variations. The infrared camera system 218 may enable the identification of living beings, heat sources, or anomalies in the environment. Note that the infrared camera system 218 can be particularly useful in applications involving security surveillance and search and rescue missions.

The LiDAR system 222 may comprise one or more lasers for emitting lasers beams configured to measure distances. The LiDAR system 222 can use the measured distances to create 3D maps of the environment around the robot. Note that the LiDAR system 222 can be used in application relating to navigation, obstacle detection, and creating accurate maps of the robot's surroundings.

The camera array system 224 may comprise a plurality of cameras for capturing images of the mobile robot's surroundings. The camera array system 224 may comprise a number of cameras facing different directions or at least one camera arrays for obtaining visual data including a 360° view of the surrounding environment of the mobile robot. The visual information generated by the camera array system 224 on the surroundings of the mobile robot can be used for tasks such as object recognition, obstacle avoidance, and environmental mapping.

The microphone system 226 may comprise one or more microphones or a microphone array to capture audio information in the proximity of the mobile robot. The microphones or the microphone array may be arranged in a specific configuration to better facilitate audio data capture. The microphone system 226 may be configured to capture audio signals from different directions and distances as to allow the mobile robot to perceive sounds and identify their sources accurately.

The gas sensor system 228 may comprise one or more gas sensors configured to detect and measure the presence of specific gases in the environment of mobile robot. Note that the gas sensor system 228 may be useful for applications involving environmental monitoring tasks, for example, in monitoring air quality and firefighting operations. The gas sensor system 228 can help ensure that the robotic system can assess the conditions of its surroundings and respond appropriately.

The radar sensor system 230 may comprise one or more radar sensors configured to use radio waves to detect and locate objects in the mobile robot's surrounding areas. Note that by emitting radio waves and analyzing the reflected signals, objects can be detected. The radar sensor system 230 can allow the robotic system to measure the distances, speeds, and directions of moving or stationary objects of interest. This system may be particular useful in adverse conditions where visibility is limited, for example, for operations in darkness, fog, rain, or dust.

The GPS system 232 may comprise a GPS module configured to provide geographical location data. For example, the GPS system 232 may be used to determine the location of the mobile robot. Note that the GPS system 232 can be useful for tasks that require precise positioning, such as mapping, geospatial analysis, and navigation over large outdoor areas.

Although not depicted, the one or more modular sensor systems can also include an inertial measurement system. The inertial measurement system may comprise one or more sensors such as accelerometers, gyroscopes, and magnetometers. These sensors may be configured to measure the mobile robot's linear acceleration, angular velocity, and magnetic field orientation. Further, these sensors may also collect information regarding the movement, orientation, and velocity of the mobile robot in real-time.

The pan-tilt system 220 may comprise one or more motorized mechanisms configured to provide additional range of motion for components that are coupled to it. For example, the pan-tilt system 220 may comprise rotating/revolving structures, linkages, platforms. The pan-tilt system 220 may provide two degrees of motion. In particular, the pan-tilt system 220 may provide a “panning” movement in the horizontal direction and/or a “tilting” movement in the vertical direction for components that are coupled to the system. According to an embodiment of the present disclosure, the pan-tilt system 220 is capable of providing 120° of horizontal rotation (for example, +/−60° horizontally from the default resting position). According to another embodiment, the pan-tilt system 220 is capable of providing 120° of vertical rotation (for example, +/−60° vertically from the default resting position). As depicted in FIG. 2a, the pan-tilt system 220 may be coupled to the headlight 214, the optical camera system 216, and the infrared camera system 218. The headlight 214 may provide sufficient light for imaging using the camera system 216. By means of the pan-tilt system 220, it is possible to pan and tilt the attached camera systems such that they can be pointed at and focused on objects of interest (for example, to keep an object in the field of view), even while the mobile robot is in motion. It should be noted that while FIGS. 2a and 2b depicts the pan-tilt system 220 as coupled to the optical camera system 216 and the infrared camera system 218, other configurations are also possible. That is, the pan-tilt system 220 may be coupled to any other components that require the additional range of motion provided by the system.

Each of the one or more modular sensor systems, the communication system 208, and the primary payload 202 may comprise one or more universal mounting interface 234 configured to electrically couple the individual components of the payload system 200, as shown in FIG. 2b. The universal mounting interface 234 may comprise cooperating interfaces on the components to be coupled such that when the cooperating interfaces of the two components are brought in contact or in very close proximity with each other, the two components can be electrically coupled such current flow through the universal mounting interface 234 for power delivery. The universal mounting interface 234 may be a magnetic based quick-charging interface system, inductive coil based interface, or other alternatives. In particular, universal mounting interface 234 may enable the power module 206 of the primary payload 202 to provide power to each component of the payload system 200. Each of the additionally coupled component may extend the electrical connection. For example, the current may be delivered from the primary payload 202 to the communication system 208 through the universal mounting interface 234 provided on the bottom of the communication system 208, then to the microphone system 226 via the universal mounting interface 234 provided on the bottom of the microphone system 226 and top of the communication system 208, so on and so forth, as depicted in FIG. 2b.

The universal mounting interface 234 may comprise cooperating structures to better couple the components of the payload system 200. For example, one of the interface provided on one component may comprise a recess that is configured to receive a corresponding protrusion provided on a second component to be coupled, as shown in FIG. 2b. According to an embodiment of the present disclosure, the universal mounting interface 234 may also be configured to physically couple the components of the payload system 200. As depicted in FIG. 2b, universal mounting interface 234 may comprise a slot (e.g. male connector) on one component to be received by a recess (e.g. female connector) on the opposing component. Further, the coupling between the components may be achieved or enhanced magnetically, for example, with attracting magnetic elements on the components to be coupled, which may be implemented in addition to any structural elements. Additionally or alternatively, other physical coupling methods such as adhesive fit, friction fit, cooperating structures, bolted connections, etc. are also possible.

According to a further embodiment of the present, one or more universal mounting interface 234 may also be provided on the base 210 for coupling of components to the base 210. Additionally, the mobile robot may also comprise one or more universal mounting interfaces to enable the coupling of the modular sensor payload system 200 to the mobile robot. Accordingly, power may be supplied to the base 210 and the mobile robot.

It should be noted that the coupling of the modular components can be arranged in any desired configuration. That is, the primary payload 202, the communication system 208, and each of the one or more modular sensor systems can be coupled in any arrangement and order. As such, the arrangement depicted in FIGS. 2a and 2b is only one such example. Additionally, further sensor systems can be added as desired. Similarly, sensor systems can also be omitted as desired. Each universal mounting interface 234 can be configured to accept any corresponding interface. Each interface may accept any one of the sensor systems, the primary payload 202, or the communication system 208. It should be noted that while FIGS. 2a and 2b depict the GPS system 232 as coupled to the base 210, it may also be coupled to another sensor system, the primary payload 202, or the communication system 208. It should be noted that the number of couplings to each modular component (i.e. individual sensor systems, the primary payload 202, and the communication system 208) is not restricted to the connections depicted in FIGS. 2a and 2b. Each of the modular components may comprise additional universal mounting interface 234 as to allow for further couplings, different coupling orientations, and different coupling configurations. It should be noted that the location of the universal mounting interface 234 is also not meant to be restrictive and other the interface may be provided at any desired location of the modular components. Note that the pan-tilt system 220 can also comprise at least one (optionally a plurality of) universal mounting interfaces such that a number of sensor systems can be controlled for panning/tilting motions as to better capture sensor data.

As the individual modular sensor system may be customized, users can swap, remove, or add sensor modules based on the requirements of different environments, ensuring the robot is equipped with the most suitable sensors for the job. That is, the modular design allows for easy customization of sensor systems according to specific exploration and inspection tasks. Also, the modular sensor payload system 200 can be scaled up or down easily by adding or removing sensor systems. This scalability may allow the performable operations of robotic system to expanded to handle more complex tasks or scaled down for simpler applications, thereby providing flexibility in deployment. The universal mounting interface 234 can also improve the ease of customization by providing simple connections such that coupling and decoupling of components may be done in a quick, easy, and simple fashion. The different and wide range of sensor systems may enable the robotic system to be deployed in a wide range of applications, including industrial settings, hazardous environments, disaster-stricken areas, and confined spaces. This improved versatility can allow the robotic system to be better suited for exploration and inspection tasks across diverse scenarios. The wide range of available sensor systems can also provide a more comprehensive environmental perception by the robotic system. Further, by processing information from various sensors, a detailed and accurate representation of the surroundings can be generated by the payload system for control of the robotic operations which can be provided to the users. These data can enhance the computation module 206's ability to make intelligent decisions during exploration and inspection missions. The modular payload system 200 can also reduce overall costs by eliminating the need for separate robots for different tasks. Users can invest in a single platform and customize its sensor systems as required, which can better optimize their investment and reduce the total cost of ownership. Moreover, faulty components can be easily replaced without extensive troubleshooting or a full replacement of the robot as the faulty modular component itself can be replaced. Further, the modular connections by means of the universal mounting interface 234 also allow for a more simplified and quicker replacement process. Additionally, the integration of new technology in the form of more advanced sensor systems may also be improved as the any system designed with the universal mounting interface 234 can be easily integrated.

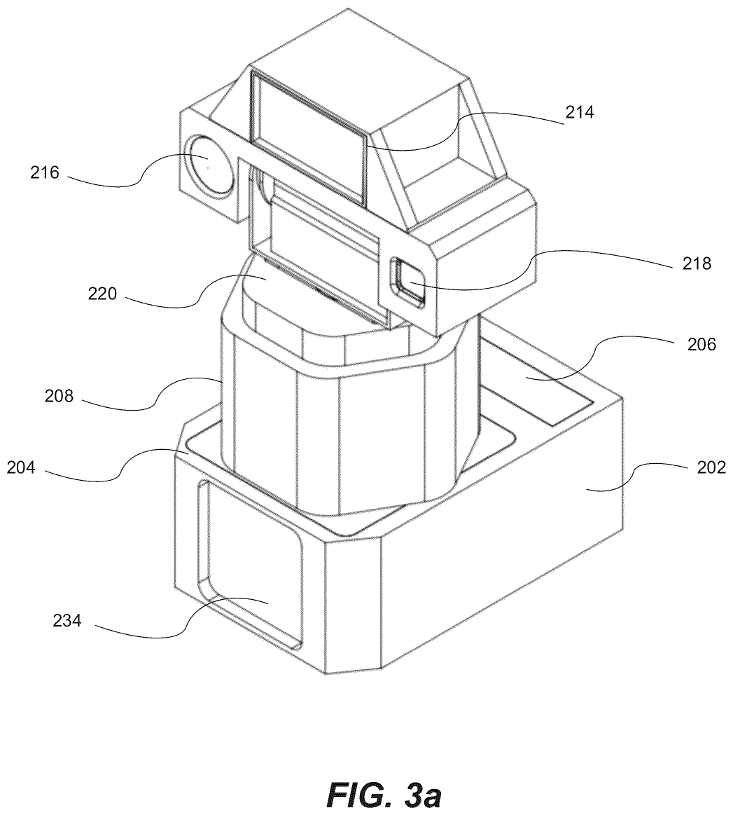

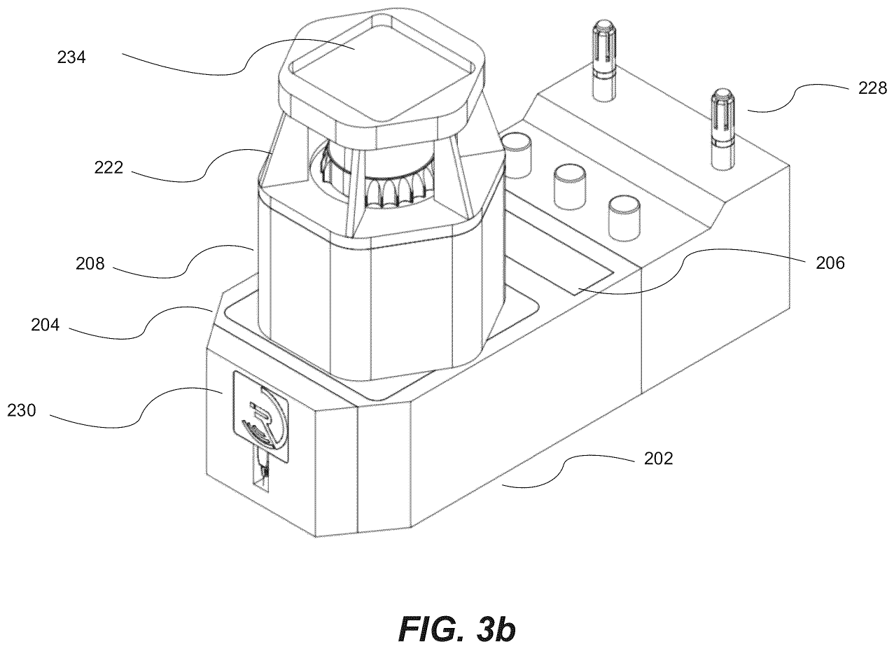

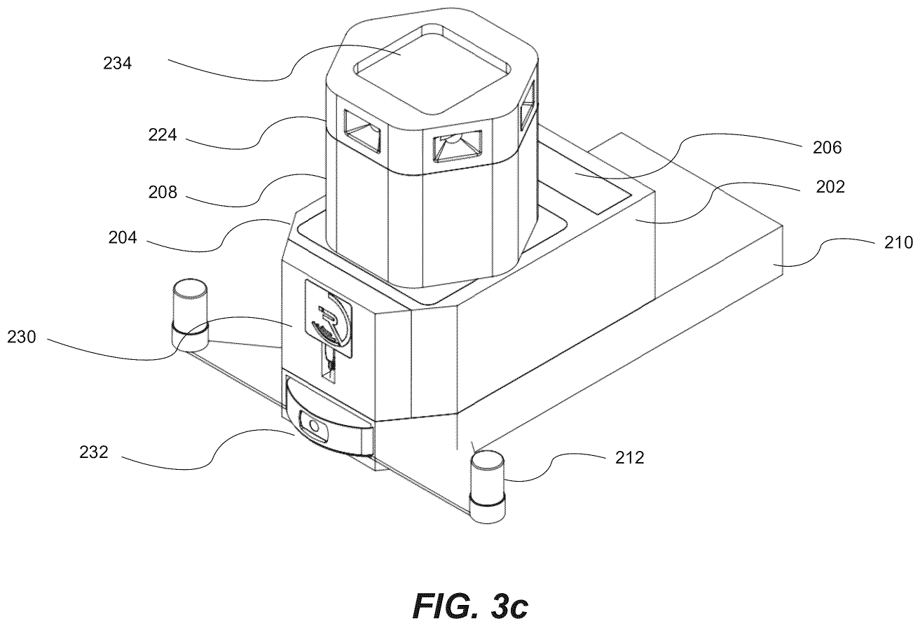

FIGS. 3a-3c depict specific embodiments and configurations of the modular sensor payload system.

FIG. 3a depicts a first modular sensor payload system comprising a primary payload 202 including an onboard power module 206 and an onboard computation module 204 is coupled to a communication system 208 and (indirectly) to one or more modular sensor systems. The one or more modular sensor systems comprises a pan-tilt system 220, an optical camera system 216, and an infrared camera system 218. A headlight 214 is also provided on top of the camera systems. It should bed noted that while an additional universal mounting interface 234 is provided on the primary payload 202, the connection is not required to be used.

FIG. 3b depicts a second modular sensor payload system comprising a primary payload 202 including an onboard power module 206 and an onboard computation module 204 is coupled to a communication system 208 and to one or more modular sensor systems. The one or more modular sensor systems comprises a radar sensor system 230, a gas sensor system 228, and a LIDAR sensor system 222. A universal mounting interface 234 for accepting additional sensor systems is shown at the top of the LiDAR sensor system 222.

FIG. 3c depicts a third modular sensor payload system comprising a primary payload 202 including an onboard power module 206 and an onboard computation module 204 is coupled to a communication system 208 and to one or more modular sensor systems. The one or more modular sensor systems comprises a radar sensor system 230, a camera array system 224, and a GPS system 232. A universal mounting interface 234 for accepting additional sensor systems is shown at the top of the camera array system 224. The primary payload 202 is also coupled to a base 210 comprising connections 212 for coupling to a mobile robot.

It should be noted that each of the configurations of the modular sensor payload systems shown in FIGS. 3a-3c are exemplary embodiments configured for different robotic operations. Further and different configurations with different coupling arrangements are also possible.

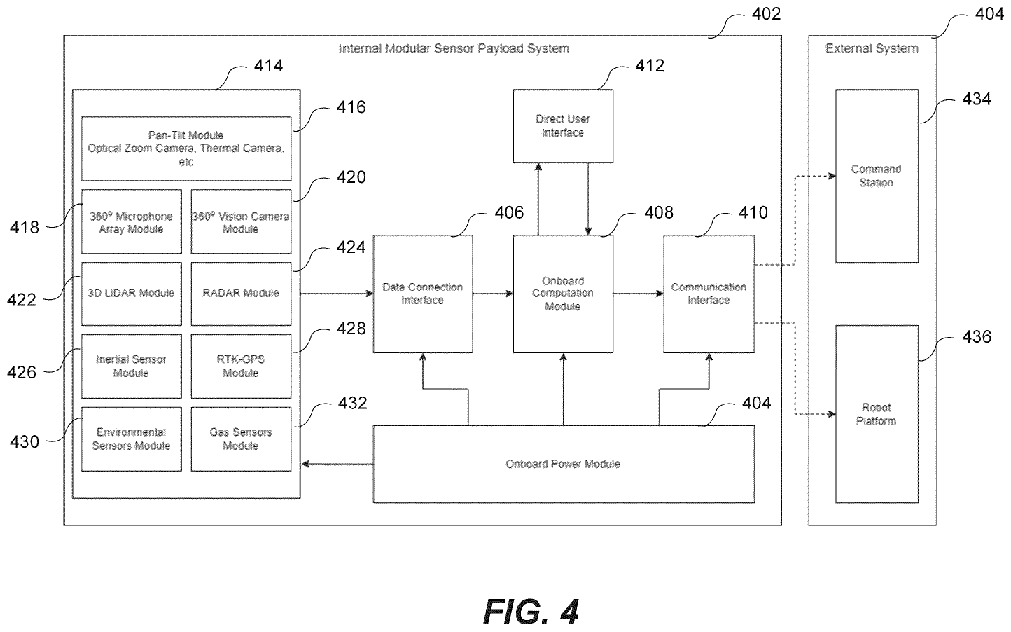

FIG. 4 depicts a representation of an embodiment of the modular sensor payload system for a mobile robot according to an embodiment of the present disclosure. The robotic system comprising the modular sensor payload system and the mobile robot can be configured to perform various robotic operations.

As shown in FIG. 4, the modular sensor payload system 402 can comprise a number of individual components including an onboard power module 404, one or more modular sensor systems 414, a data connection interface 406, an onboard computation module 408, and a communication interface 410. The modular payload system can additionally comprise a direct user interface 412.

The onboard power module 404 may be a power source, for example, a rechargeable battery, and can be configured to deliver power to the one or more modular sensor systems 414, the data connection interface 406, the onboard computation module 408, and the communication interface 410.

The one or more modular sensor systems 414 can comprise a pan-tilt module 416, which may be coupled to an optical zoom camera system and/or a thermal camera system for collecting visual and/or thermal data, a microphone array module 418 for collecting audio data, a camera array module 420 comprising cameras for collecting 360° visual data of the surroundings, a LIDAR module 422 for 3D mapping and collecting distance related data, a radar module 424 for object detection and tracking, an inertial sensor module 426 for collecting velocity, acceleration, and orientation data, a GPS module 428 for collecting location data, an environmental sensor module 430 for collecting temperature and humidity data, and a gas sensor module 432 for detecting and measuring the presence of gases. It should be noted that any combination of the described modules may be implemented for the payload system 402 and that not all of the described modules must be implemented.

The collected sensor data from the modular sensor systems 414 can be transmitted to the onboard computation module 408 by means of the data connection interface 406. The data connection interface 406 can be configured to transmit the sensor data to the onboard computation module 408. The data connection interface 406 may process the data by normalizing, filtering, and integrating the sensor data before it is transmitted to the onboard computation module 408. This process may improve the data processing efficiencies of the onboard computation module 408 by reducing the processing burden and improving data uptake and integration.

The onboard computation module 408 can be configured to process the sensor data in real time. The onboard computation module 408 may process the data using at least one algorithms for perception, decision-making, and control. Based on the processed sensor data, the onboard computation module 408 may be able to make autonomous decisions with regard to the operations of the modular sensor payload system 402 and/or the mobile robot. For example, the onboard computation module 408 may provide instructions to the mobile robot to move in a certain direction or at a certain speed, to perform specific actions, etc. As another example, the onboard computation module 408 may instruct/control the optical camera to capture image data of a particular object. The onboard computation module 408 can also generate output data with regard to the sensor data, the state of the modular sensor payload system 402, the mobile robot, as well as the robotic operations being performed.

The data produced by the onboard computation module 408 (i.e. processed sensor output data, instructions) may be transmitted to an external system 404 or to the sensor systems 414 through the communication interface 410. The communication interface 410 may be adapted for wired or wireless data communication with the sensor systems 414 and/or the external system 434. For example, data to and from the external system 434 may be communicated through a network (i.e. WiFi, Bluetooth). It should be noted that the data connection interface 406 and the communication interface 410 may be implemented as a single system or component.

In some embodiments, the modular sensor payload system 402 may comprise a direct user interface 412 coupled to the onboard computation module 408. The direct user interface 412 may be a physical interface provided on the modular sensor payload system 402 for the user to input direct commands or instructions for controlling the modular sensor payload system 402 and the mobile robot through the onboard computation module 408. Further, the direct user interface 412 may also be configured to display the data produced by the onboard computation module 408. It should be noted that the direct user interface 412 may be alternatively coupled to the data connection interface 406 or the communication interface 410.

The external system 404 may be one or more of a command station 434 and a robot platform 436. For example, the mobile robot coupled to the modular sensor payload system 402 may be the robot platform 436. The robot platform 436 may receive data in the form of instructions from the modular sensor payload system 402 (e.g. from the communication interface 410). By processing the received data, the robot platform 436 may be configured to perform various robotic operations. The command station 434 may be one or more remote devices in communication with the modular sensor payload system 402. The devices can include devices such as phones, tablets, computers, controllers, etc. The command station 434 may be configured to control the operations of the modular sensor payload system 402 and the robot platform 436 by providing instructions to the modular sensor payload system 402 remotely. The command station 434 may also be configured to monitor the payload system 402 and robot platform 436 by receiving and displaying data produced by the onboard computation module 408. According to a another embodiment, the command station 434 may be configured to store and analyze the data received from the modular sensor payload system 402.

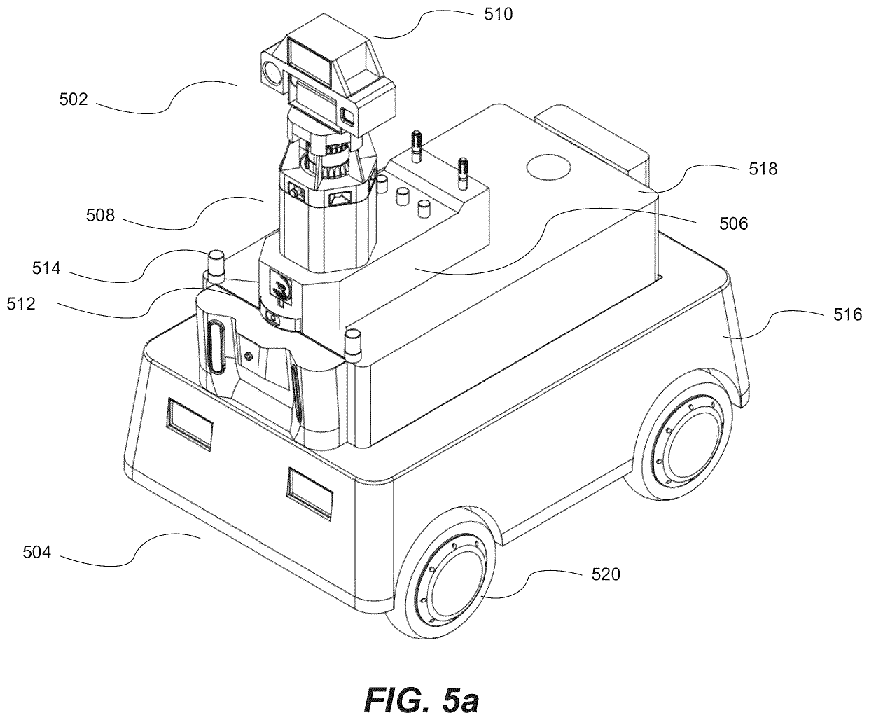

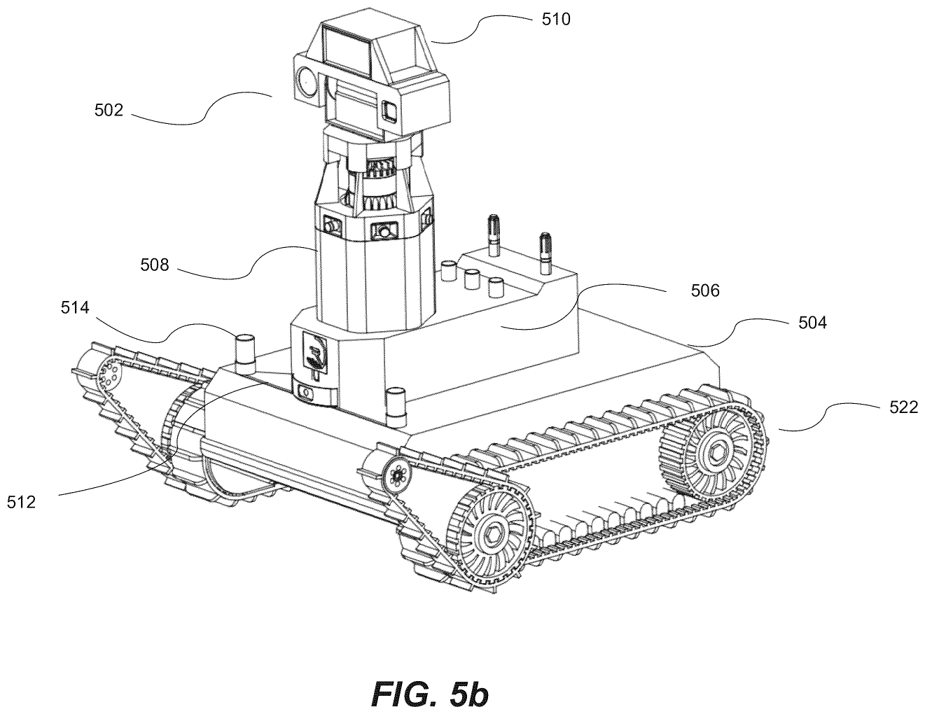

FIGS. 5a and 5b show embodiments of the modular sensor payload system with different mobile robots.

FIG. 5a depicts a modular sensor payload system 502 coupled to a mobile robot 504. The modular sensor payload system 502 comprises a primary payload 506, a communication module 508, and one or more modular sensor systems 510. The primary payload 506 may be coupled to a base 512 that is coupled to the mobile robot 504 at one or more connection locations 514. The mobile robot 504 can comprise a main body 516 and a robot payload 518. The movement of the mobile robot 504 may be achieved by means of the wheels 520.

Similarly, FIG. 5b depicts a modular sensor payload system 502 coupled to a mobile robot 504. The modular sensor payload system 502 comprises a primary payload 506, a communication module 508, and one or more modular sensor systems 510. The primary payload 506 may be coupled to a base 512 that is coupled to the mobile robot 504 at one or more connection locations 514. The mobile robot 504 can comprise a main body 516 and a robot payload 518. The movement of the mobile robot 504 may be achieved by means of treads 522, which may provide better traction and movement in more complicated/difficult terrain.

It should be noted that other types of mobile robots, such as drones, can also be adapted for use with the modular sensor payload system of the present disclosure.

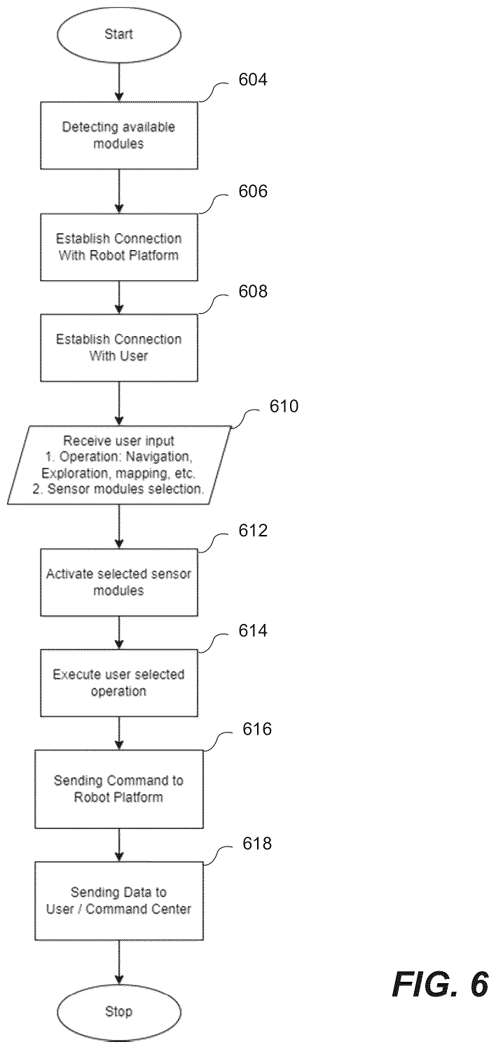

FIG. 6 depicts a method for performing robotic operations for a robotic system comprising a modular sensor payload system and a mobile robot in accordance with an embodiment of the present disclosure. The payload system may be initialized, during which connections between the various components of the payload system can be established. For example, the primary payload may establish power connection and data connection with each of the components. The payload system (e.g. the onboard computation module by means of the communication system) may detect the modules that are implemented or coupled to the payload (604). In particular, the primary payload may determine/confirm the coupled sensor systems and connect with each of the coupled modular sensor systems as to ensure that data can be exchanged and power can be delivered. When coupled, each of the components and particularly the sensor systems may be configured to transmit information regarding its availability to the payload system (e.g. the onboard computation module). The payload system may also scan for attached components/sensor systems upon initialization by detecting and processing the transmitted availability information. The payload system may establish a data connection with the mobile robot (606), for example, by means of the communication system. A connection with the user may also be established (608). The connections can be established over a communications network or directly. For example, connections to the mobile robot can be established over a cable or through electrically coupling over the universal mounting interface. The user may also directly establish connection(s) to the mobile robot/sensor systems (e.g. using the communication interface). In particular, the payload system may establish the data connection wirelessly over a communication network using the communication system to one or more remote devices operated by the user. Alternatively or additionally, the data connection may be provided using a direct user interface (e.g. the communication interface). The user may provide input over the established connection(s) to the payload system (610). In particular, the user may select, from the detected list of available sensor systems, the sensor systems to be used for robotic operations. The user may also provide instructions for the payload system with regard to the operations to be performed. For example, the user may direct the robotic system to perform exploration over a specific area, to map a particular area, to navigate a building, to conduct searches, etc. The payload system can subsequently activate the sensor systems selected by the user. That is, the un-activated sensor systems may be in a “rest” mode or may not receive power from the primary payload. This may increase power efficiency and increase operation time by eliminating power delivery to unused sensor systems. Further, this may reduce deployment time and increase ease of use in that the configuration of the sensor systems are not altered between separate operations. The payload system can then execute the operations to be performed as input by the user (614) by operating the sensor systems and sending instructions to the robot platform (618).

Note that the user may operate the mobile robot and the payload system remotely in real time. The user can provide updated instructions for the robotic system during operation, for example, to control the movement thereof (e.g. operations of the mobile robot) as well as to control the sensor data to be captured (e.g. operations of the individual sensor systems). The robotic system can also operate autonomously, for example to control the operations of the mobile robot and the individual sensor systems via the onboard computation module. The computation module can have algorithms stored thereon which can control the robotic system in real time including operation the sensor systems according to the received sensor data as well as user instructions.

It would be appreciated by one of ordinary skill in the art that the system and components shown in the figures may include components not shown in the drawings. For simplicity and clarity of the illustration, elements in the figures are not necessarily to scale and are only schematic. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification.

It should be recognized that features and aspects of the various examples provided above can be combined into further examples that also fall within the scope of the present disclosure.

When used in this specification and claims, the terms “comprises” and “comprising” and variations thereof mean that the specified features, steps or integers are included. The terms are not to be interpreted to exclude the presence of other features, steps or components. Further, as used herein, the term “comprising” can mean “including.” Variations of the word “comprising”, such as “comprise” and “comprises,” have correspondingly varied meanings. Thus, for example, a composition “comprising” X may consist exclusively of X or may include one or more additional unrecited components. It will be understood that in embodiments which comprise or may comprise a specified feature or variable or parameter, alternative embodiments may consist, or consist essentially of such features, or variables or parameters. A reference to an element by the indefinite article “a” does not exclude the possibility that more than one of the elements is present, unless the context clearly requires that there be one and only one of the elements.

Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

The terms are not to be interpreted to exclude the presence of other features, steps or components. Further, the singular forms “a”, “an”, and “the” are intended to include the plural forms as well, unless the context clearly indicates otherwise.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present. Further, in this disclosure, the term “or” is generally employed in its sense including “and/or” unless the content clearly dictates otherwise.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied herein disclosed may be resorted to by those skilled in the art, and that such modifications and variations are considered to be within the scope of this invention.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

1. A modular sensor payload system for a mobile robot, comprising:
one or more sensor systems,
a primary payload comprising:
an onboard computation module configured to process sensor data from the one or more sensor systems and to generate output data;
an onboard power module configured to provide power to the modular sensor payload system, and
a communication system comprising:
a data connection module configured to provide communication between the onboard computation module and the one or more sensor systems; and
a data interface module configured to provide communication between the modular sensor payload system and the mobile robot, and
wherein the one or more sensor systems, the communication system, and the primary payload are configured to be electrically coupled in a modular configuration via an universal mounting interface provided on each of the one or more sensor systems, the communication system, and the primary payload, and
wherein a given sensor system of the one or more sensor systems can be coupled to any other sensor system, the communication system, or the primary payload in the modular configuration.

2. The modular sensor payload system of claim 1, wherein the sensor data is wirelessly provided to the onboard computation module.

3. The modular sensor payload system of claim 1, wherein the power to the modular sensor payload system is provided through the universal mounting interface.

4. The modular sensor payload system of claim 1, wherein
the output data is for controlling operations of the one or more sensor systems; and/or
the output data is for controlling operations of the mobile robot.

5. The modular sensor payload system of claim 1, wherein
the data interface module is further configured to provide communication between the payload system and one or more external devices; and
the onboard computation module is configured to process information from the one or more external devices to generate the output data.

6. The modular sensor payload system of claim 5, wherein
operations of the payload system is controlled by the one or more external devices; and/or
operations of the mobile robot is controlled by the one or more external devices.

7. The modular sensor payload system of claim 5,
wherein the output data is provided to the one or more external devices; and
wherein the one or more external devices is a phone, a computer, a remote controller, a database, or combinations thereof.

8. The modular sensor payload system of claim 1, wherein at least one system comprises:
a processor configured to process received data and control the operations of the at least one sensor system according to the received data.

9. The modular sensor payload system of claim 1, wherein the one or more sensor systems comprise a pan-tilt system configured to provide movement to at least one sensor system attached thereon.

10. The modular sensor payload system of claim 1, wherein the one or more sensor systems comprise one or more of:
an optical camera system configured to capture camera images;
an infrared camera system configured to capture infrared images; and
a camera array system configured to capture visual images of a surrounding.

11. The modular sensor payload system of claim 1, wherein the one or more sensor systems comprise an inertial measurement system configured to measure acceleration, velocity, angular velocity, orientation, magnetic field orientation, or combinations thereof.

12. The modular sensor payload system of claim 1, wherein the one or more sensor systems comprise: a light detection and ranging system, a radar system, a GPS system, or combinations thereof.

13. The modular sensor payload system of claim 1, wherein the one or more sensor systems comprise: a microphone system, a gas sensor system, an environmental sensor system, or combinations thereof.

14. The modular sensor payload system of claim 1, further comprising a direct user interface configured to receive user input to control the modular sensor payload system and/or the mobile robot.

15. The modular sensor payload system of claim 1, wherein
the universal mounting interface comprises a cooperating feature configured to provide an electrical interface;
the universal mounting interface comprises a male interface and a female interface, the male interface configured to be inserted in a corresponding female interface, and the female interface configured to receive a corresponding male interface; and
the one or more sensor systems, the communication system, and the primary payload are configured to be physically coupled in the modular configuration via the universal mounting interface.

16. The modular sensor payload system of claim 1, wherein the universal mounting interface is a magnetic connection interface or wireless connection interface.

17. A mobile robot for performing independent remote operations, the mobile robot comprising:
a main body, and
a modular sensor payload system comprising:
one or more sensor systems,
a primary payload comprising:
an onboard computation module configured to process sensor data from the one or more sensor systems and to generate output data;
an onboard power module configured to provide power to the modular sensor payload system, and
a communication system comprising:
a data connection module configured to provide communication between the onboard computation module and the one or more sensor systems; and
a data interface module configured to provide communication between the modular sensor payload system and the mobile robot, and
wherein the one or more sensor systems, the communication system, and the primary payload are configured to be electrically coupled in a modular configuration via an universal mounting interface provided on each of the one or more sensor systems, the communication system, and the primary payload, and
wherein a given sensor system of the one or more sensor systems can be coupled to any other sensor system, the communication system, or the primary payload in the modular configuration.

18. A method of controlling a mobile robot using a modular sensor payload system, the method comprising:
detecting one or more sensor systems of the modular sensor payload system,
establishing communication between the modular sensor payload system and the mobile robot,
receiving input instructions from a user,
operating the one or more sensor systems based on the input instructions,
wherein the modular sensor payload system comprises:
one or more sensor systems,
a primary payload comprising configured for robotic control, and
a communication system configured to provide communication between the primary payload, the one or more sensor systems, and the user, and
wherein the one or more sensor systems, the communication system, and the primary payload are configured to be electrically coupled in a modular configuration via an universal mounting interface provided on each of the one or more sensor systems, the communication system, and the primary payload, and
wherein a given sensor system of the one or more sensor systems can be coupled to any other sensor system, the communication system, or the primary payload in the modular configuration.

19. The method according to claim 18, further comprising: controlling operations of the mobile robot according to the input instructions and sensor data from the one or more sensor systems.

20. The method according to claim 18, further comprising: generating output data for the user.
